(19) United States
(12) Patent Application Publication
(10) Pub. No.: US 2011/0211241 A1
(43) Pub. Date: Sep. 1, 2011

(54) DRIVE CONTROL DEVICE OF LIGHT SCANNING APPARATUS

(75) Inventors: Kenta Ide, Nagano (JP); Kouji Hamachi, Nagano (JP)

(73) Assignee: SHINANO KENSHI KABUSHIKI KAISHA, Ueda-shi (JP)

(21) Appl. No.: 13/023,064

(22) Filed: Feb. 8, 2011

(30) Foreign Application Priority Data
Feb. 26, 2010 (JP) 2010-043188

(51) Int. Cl. G02B 26/10

(52) U.S. Cl. 359/198.1

(57) ABSTRACT

The drive control device of a light scanning apparatus can be easily controlled, occurrence of overshoot can be prevented, and a scanning range of a mirror section can be adjusted in a short time. An amplitude adjusting section generates at least one of first adjusting voltage for acceleration, whose amplitude is higher than that of adjusting voltage for obtaining object amplitude, and second adjusting voltage for deceleration, whose amplitude is lower than that of the adjusting voltage for obtaining the object amplitude, and applies the same to a drive circuit for a prescribed time, to perform feedback control, when a comparing section generates an error signal, so as to cancel increase-decrease variation of the error signal.

### CROSS-REFERENCE TO RELATED APPLICATION

This application is based upon and claims the benefit of priority of the prior Japanese Patent Application No. P2010-043188, filed on Feb. 26, 2010, and the entire contents of which are incorporated herein by reference.

### FIELD

The present invention relates to a control device of a light scanning apparatus, in which scanning operation is performed by reflecting a light beam irradiated from a light source with a swung mirror section.

### BACKGROUND

A light scanning apparatus, which scans with a light, e.g., laser beam irradiated from a light source, is used in an optical equipment, e.g., barcode reader, laser printer, head mounted display, or an imaging equipment, e.g., infrared camera.

A conventional light scanning apparatus will be explained. A mirror section is provided in an opening part of a rectangular substrate, which is composed of, for example, stainless steel or silicon, and both sides of the mirror section are connected to the substrate by a beam section. A surface of the mirror section is polished like a mirror, reflection coating is formed on the surface of the mirror section, or a mirror is adhered thereon.

A vibration source, which is composed of a film of a piezoelectric substance, a magnetostrictive substance or a permanent magnet, is provided on the substrate. For example, in case of using the piezoelectric substance, the vibration source is extended by applying positive voltage and shrunk by applying negative voltage, so that the substrate is bent. By repeatedly bending the substrate upward and downward, twisting vibration is generated in the beam section, so that the mirror section can be swung on the beam section.

With this structure, great vibration can be generated in the mirror section by a small vibration source. Further, production cost can be lower than that of a conventional light scanning apparatus, in which a minute mirror produced by a micro electro mechanical system (MEMS) is swung (see Japanese Laid-open Patent Publication No. P2006-293116A).

To control the light scanning apparatus, two sensors, which respectively generate sensor signals, are located at both side limits of a scanning range of the mirror section. A time interval between the sensor signals of the two sensors, and the time interval is compared with a standard value of the time interval for feedback control so as to stabilize vibration of the mirror section. Voltage applied for vibrating the mirror section is corrected or adjusted by the feedback control. For example, as shown in FIG. 11, amplitude of voltage signals for vibrating the mirror section is increased or decreased so as to perform the feedback control.

However, in case that controlling a swing range of the mirror section is feedback-controlled by calculation performed by a control section, e.g., CPU, response of varying the scanning range with respect to variation of drive voltage will be slow due to Q value of resonance frequency, a width of the scanning range, etc. In that case, it takes a long time to adjust the scanning range to a predetermined range from occurrence of the variation of the drive voltage. Therefore, significant phase lag of the scanning range occurs, and high-precision and high-sensitive control cannot be performed.

FIG. 12 shows waveform charts in a state where an error signal is generated and the scanning range is adjusted by applying adjusting voltage to drive voltage. FIG. 12 shows the waveform charts of: vibration of the mirror section indicating the swing range thereof; the adjusting voltage for adjusting the scanning range of the mirror section; and an error signal whose voltage corresponds to the scanning range. When the scanning range of the mirror section is smaller than an object range, the adjusting voltage V1 is applied to the drive voltage so as to increase the scanning range. An amount of increasing the scanning range corresponds to level e1 of the error signal. However, it takes a long time t1 to adjust the scanning range because frequency response to the variation of the drive voltage is slow.

FIG. 13 shows waveform charts in a state where response of varying the scanning range is quickened. In case of applying adjusting voltage V2 which is higher than the adjusting voltage V1 shown in FIG. 12, the scanning range corresponding to level e2 of the error signal is greater than that corresponding to the level e1 of the error signal. In this case, it takes a time t2, which is shorter than the time t1 shown in FIG. 12, to adjust the scanning range to the object range. Therefore, in case that high adjusting voltage is applied to the drive voltage, the scanning range can be adjusted in a short time. Note that, the relationship between the adjusting voltage and a time for converging or adjusting the scanning range is not varied linearly, so the convergence is not always performed in tithe ( 1/10) of the time by decupling the adjusting voltage.

As described above, if the adjusting voltage applied to the drive voltage is low, response of varying the scanning range is slow, the scanning range cannot be adjusted in a sufficient short time, phase lag of the scanning range occurs, and high-precision control cannot be performed. Thus, the phase lag of the scanning range can be prevented by highly increasing the adjusting voltage to sharply vary the scanning range. The scanning range can be sharply varied by applying high adjusting voltage, but the scanning range will be excessively varied beyond an object range so that overshoot will occur.

### SUMMARY

Accordingly, it is an object in one aspect of the invention to provide a drive control device of a light scanning apparatus which can be easily controlled and in which occurrence of the overshoot can be prevented and a scanning range of a mirror section can be adjusted in a short time.

To achieve the object, the drive control device of the light scanning apparatus, in which a substrate is vibrated by a vibration source provided on the substrate so as to swing a mirror section on a beam section as a pivot shaft and reflect irradiated light for light scanning, comprises:
a frequency generating section for generating electric signals having an assigned frequency;
an amplitude adjusting section for adjusting amplitude of the electric signals and outputting the electric signals whose amplitude has been adjusted;
a drive circuit applying drive voltage, which corresponds to the adjusted amplitude of the electric signals sent from the amplitude adjusting section, to the vibration source so as to actuate the vibration source;
a detecting section for detecting a swing range of the mirror section swung by the vibration source, which is actuated by the drive voltage;
a measuring section for measuring a time interval between detection signals outputted by the detecting section;
a standard value setting section for setting and generating a standard value of the time interval between the detection signals; and
a comparing section for comparing the measured time interval, which has been measured by the measuring section, with the standard value of the time interval, and

the amplitude adjusting section generates at least one of first adjusting voltage for acceleration, whose amplitude is higher than that of adjusting voltage for obtaining object amplitude, and second adjusting voltage for deceleration, whose amplitude is lower than that of adjusting voltage for obtaining the object amplitude, and applies the same to the drive circuit for a prescribed time, to perform feedback control, when the comparing section generates an error signal, so as to cancel increase-decrease variation of the error signal.

Preferably, the amplitude adjusting section generates the first adjusting voltage and the second adjusting voltage on the basis of the increase-decrease variation of the error signal so as to cancel the variation and adjust the swing range of the mirror section to an object swing range.

The amplitude adjusting section generates at least one of the first adjusting voltage for acceleration, whose amplitude is higher than that of the adjusting voltage for obtaining the object amplitude, and the second adjusting voltage for deceleration, whose amplitude is lower than that of the adjusting voltage for obtaining the object amplitude, and applies the same to the drive circuit for the prescribed time, to perform the feedback control, so as to cancel the increase-decrease variation of the error signal. By applying the first or second adjusting voltage to the adjusting voltage, on the basis of an error value of the swing range (scanning range) of the mirror section, for a short time, the scanning range of the mirror section can be adjusted to the object range, without occurring overshoot, in a short time.

Especially, in case that the amplitude adjusting section generates the first adjusting voltage and the second adjusting voltage on the basis of the increase-decrease variation of the error signal so as to cancel the variation and adjust the swing range of the mirror section to the object range, even if the scanning range is made more than or less than the object range, it can be adjusted to the object range in a short time. Therefore, control problems, e.g., sampling error of drive frequency, can be prevented before happens.

### BRIEF DESCRIPTION OF THE DRAWINGS

Embodiments of the present invention will now be described by way of examples and with reference to the accompanying drawings, in which:

FIG. 1A is a plan view of a light scanning apparatus;

FIG. 1B is a sectional view taken along a line A-A shown in FIG. 1A;

FIG. 2 is an explanation view of sensors for detecting a swing range of a mirror section and sensor signals outputted from sensors;

FIG. 3 is a block diagram of a drive control device of the light scanning apparatus;

FIG. 4 shows waveform charts indicating relationship between a scanning range, an error signal and adjusting voltage;

FIG. 5 shows waveform charts indicating relationship between first adjusting voltage for acceleration and an output time of the first adjusting voltage;

FIG. 6 shows waveform charts indicating relationship between the first adjusting voltage for acceleration and another output time of the first adjusting voltage;

FIG. 7 is a waveform chart of the first adjusting voltage for acceleration and second adjusting voltage for deceleration;

FIG. 8 shows waveform charts indicating relationship between the scanning range, the error signal, the first adjusting voltage and the second adjusting voltage applied to the adjusting voltage;

FIG. 9 shows waveform charts indicating relationship between the scanning range, the error signal, and the adjusting voltage to which no first and second adjusting voltage are applied;

FIG. 10 shows waveform charts indicating relationship between the scanning range, the error signal, and the adjusting voltage to which the first and second adjusting voltage are applied;

FIG. 11 shows the waveform charts of the conventional technology, which indicate the relationship between the scanning range, the drive voltage and the adjusting voltage;

FIG. 12 shows the waveform charts of the conventional technology, which indicate the relationship between the scanning range, the error signal and the adjusting voltage; and

FIG. 13 shows the waveform charts of the conventional technology, which indicate the relationship between the scanning range, the error signal and the adjusting voltage.

### DETAILED DESCRIPTION OF THE EMBODIMENTS

Preferred embodiments of the present invention will now be described in detail with reference to the accompanying drawings. In the following embodiments, a scanner for a laser beam printer will be explained as a light scanning apparatus.

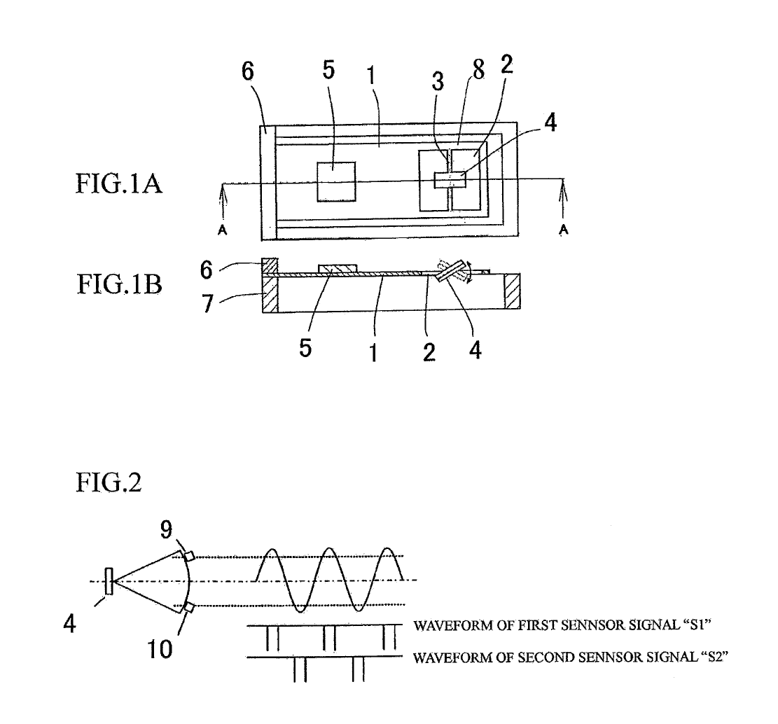

An outline of the light scanning apparatus will be explained with reference to FIGS. 1A and 1B.

A substrate 1 is a rectangular plate composed of, for example, stainless steel (SUS304), silicon (Si), etc. One longitudinal end of the substrate 1 is clamped by a clamping member 6 and a holding member 7, so that the substrate 1 is held like a cantilever.

A frame part 8 is formed at the other end (free end) of the substrate 1.

A mirror section (an optical MEMS mirror) 4 is provided in an opening part 2, which is enclosed with the frame part 8, and both sides of the mirror section 4 are supported by a beam section 3.

A vibration source 5 is provided on the substrate 1 and located close to the one end side the substrate 1. The vibration source 5 is a piezoelectric element composed of lead zirconate titanate (PZT) and adhered to the substrate 1. The substrate 1 is vibrated by actuating the vibration source 5, so that the mirror section 4 can be swung, on the beam section 3 as a pivot shaft, with reflecting a laser beam. With this action, the light scanning operation can be performed.

Besides the piezoelectric element, a film of a piezoelectric substance, a magnetostrictive substance or a permanent magnet may be directly formed on the substrate 1 as the vibration source 5. The film may be formed by a known film forming method, e.g., aerosol deposition (AD) method, vacuum evaporation method, sputtering method, chemical vapor deposition (CVD) method, sol-gel method. By directly forming the film of a piezoelectric substance, a magnetostrictive substance or a permanent magnet on the substrate 1, a light scanning apparatus, which is driven at a low voltage and whose electric power consumption is low, can be produced.

In case of employing a magnetostrictive substance or a permanent magnet as the vibration source 5, by applying alternate magnetic fields to a coil located in the vicinity of the film of the magnetostrictive substance or permanent magnet formed on the substrate 1, an alternate current passes through the coil, so that alternate magnetic fields are generated. Note that, in case of forming the film of the magnetostrictive substance or permanent magnet formed on the substrate 1, a nonmagnetic material is suitably selected as a material of the substrate 1 so as to efficiently bend the substrate 1.

Note that, the mirror section 4 has a base plate. The base plate may be a metal plate whose surface is mirror-finished. In case that the base plate is composed of a non-metallic material or the base plate having high reflexivity is required, a thin mirror film may be formed on the base plate by a known film forming method, e.g., vacuum evaporation method, sputtering method, chemical vapor deposition (CVD) method, or by adhering a mirror surface member thereon.

The thin mirror film is composed of a material selected from gold (Au), silicon dioxide (SiO₂), aluminum (Al) and magnesium fluoride (MgF₂), or a combination of two or more. Further, by suitably controlling a thickness of a single-layer film or a total thickness of a multilayer film, reflexivity of the thin mirror film can be improved. For example, the mirror surface member to be adhered onto the mirror section 4 may be produced by forming the thin mirror film on a mirror-finished ceramic plate, e.g., silicon (Si), alumina titanium carbide (Al₂O₃—TiC), by said known film forming method.

In case that the base plate is composed of silicon (Si), stainless steel (e.g., SUS304), etc. or carbon nanotubes will be grown on the base plate, a desired thickness of the base plate is 10 μm or more in light of flatness of the mirror section 4 in operation and a required mirror size of a projector device, etc.

As shown in FIG. 2, a first photoelectronic sensor 9 and a second photoelectronic sensor 10 are respectively provided at both side limits of a scanning range of the mirror section 4. The first and second sensors 9 and 10 act as the detecting sections. When the first sensor 9 senses reflected light, the first sensor 9 outputs a first sensor signal (detection signal) S1; when the second sensor 10 senses reflected light, the second sensor 10 outputs a second sensor signal (detection signal) S2.

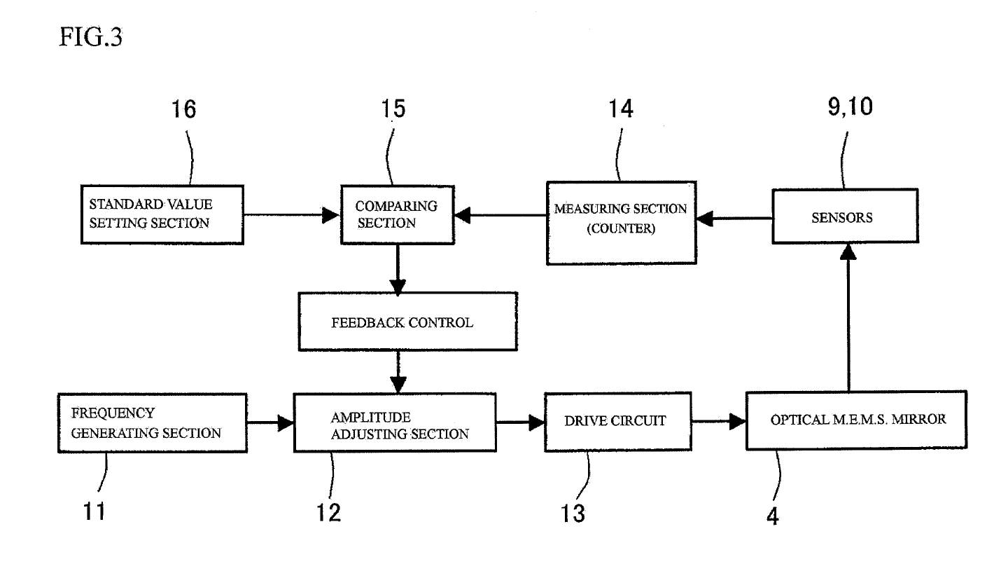

Next, a concrete example of the drive control device of the light scanning apparatus will be explained with reference to a block diagram of FIG. 3. In the drive control device, a time interval between the first sensor signal S1 and the second sensor signal S2 is measured, and the measured time interval is compared with a standard time interval so as to perform feedback control, so that the scanning range of the mirror section 4 can be stabilized. The structure of the drive control device and the feedback control will be explained.

In FIG. 3, a frequency generating section 11 generates electric signals having a predetermined frequency. An amplitude adjusting section 12 adjusts amplitude of the electric signals and sends the adjusted electric signals to a drive circuit 13. The drive circuit 13 applies drive voltage, which corresponds to the adjusted amplitude of the electric signals sent from the amplitude adjusting section 12, to the vibration source 5 so as to actuate the vibration source 5. Therefore, the mirror section 4 is swung on the beam section 3. The first and second photoelectronic sensors 9 and 10, which act as the detecting sections, detect a swing range of the mirror section 4, which is swung by the drive voltage applied from the drive circuit 13. A counter 14 measures the time interval between the first and second sensor signals outputted by the first and second photoelectronic sensors 9 and 10, as the measuring section (see FIG. 2). A comparing section 15 compares the measured time interval, which has been measured by the counter 14 and which indicates an actual scanning range of the mirror section 4, with a standard value of the time interval, which indicates an object scanning range of the mirror section 4 and which has been set by a standard value setting section 16 and stored therein. The comparing section 15 generates an error signal which indicates difference between the actual scanning range and the object scanning range. The amplitude adjusting section 12 calculates adjusting voltage, on the basis of the comparison result, and adjusts voltage applied to the drive circuit 13.

In case of adjusting the drive voltage applied to the vibration source 5, the inventor thinks that the scanning range of the mirror section 4 can be sharply varied and converged in a short time by applying high voltage, which is higher than the object adjusting voltage, which has been calculated by the amplitude adjusting section 12, for a short time.

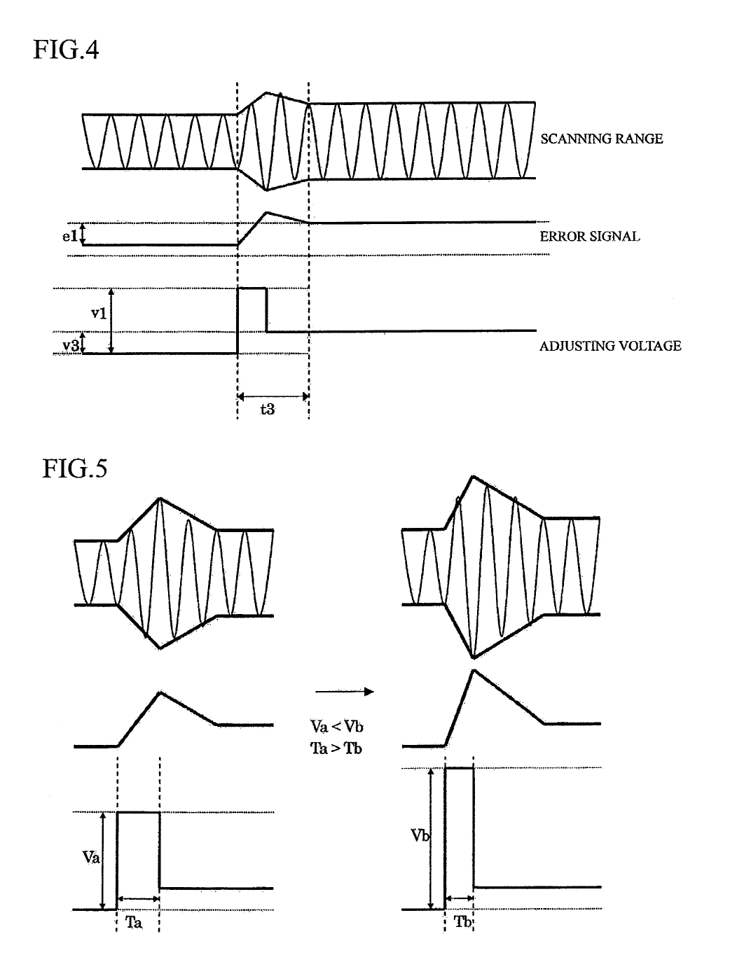

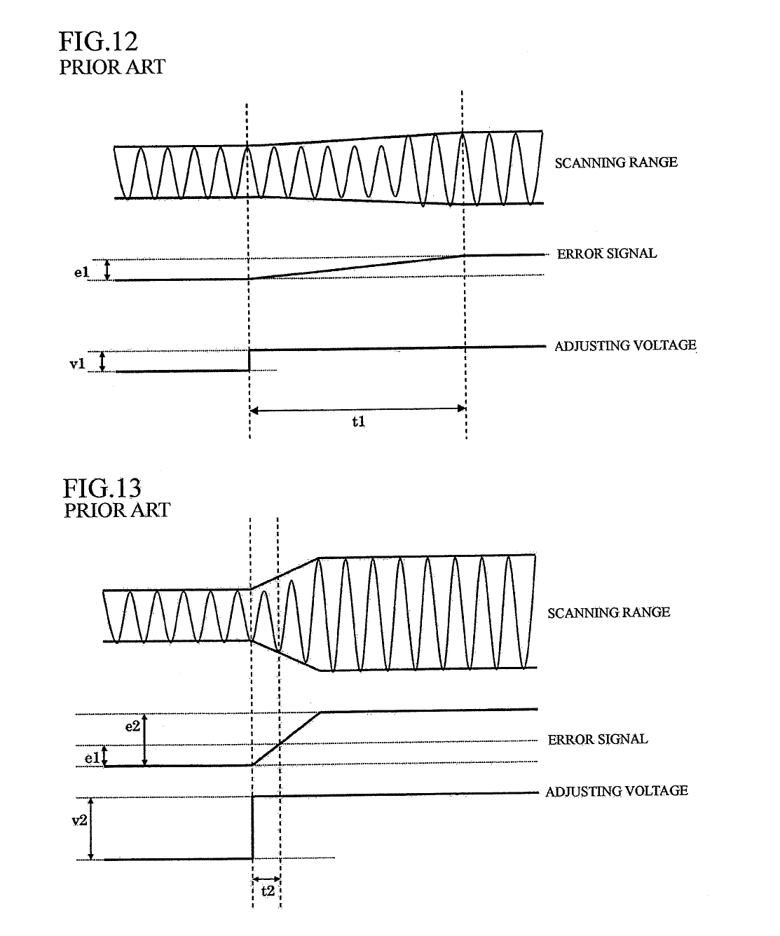

FIG. 4 shows waveform charts, in which first adjusting voltage V1 for acceleration, which is higher than the adjusting voltage V3 for increasing the scanning range of the mirror section 4, is applied to the adjusting voltage so as to cancel variation e1 (increase-decrease value) of an error signal which indicates that the scanning range is smaller than an object scanning range. In case that the scanning range of the mirror section 4 is increased an amount corresponding to the variation e1 of the error signal, if only the adjusting voltage V3 is applied, it takes a time t1 to vary the scanning range as shown in FIG. 12. However, in the present embodiment, the first adjusting voltage V1 higher than the adjusting voltage V3 is applied, in a short time, to the adjusting voltage V3. Therefore, the scanning range is sharply varied immediately after applying the first adjusting voltage V1, and the scanning range can be converged in a time t3, which is shorter than the time t1 shown in FIG. 12, with occurring overshoot.

In case that the scanning range is converged on the object range in a time shorter than the time t3, as shown in FIG. 5, the first adjusting voltage, which is applied to the adjusting voltage, is increased from Va to Vb, and a time Tb for applying the first adjusting voltage Vb is made shorter than a time Ta for applying the first adjusting voltage Va.

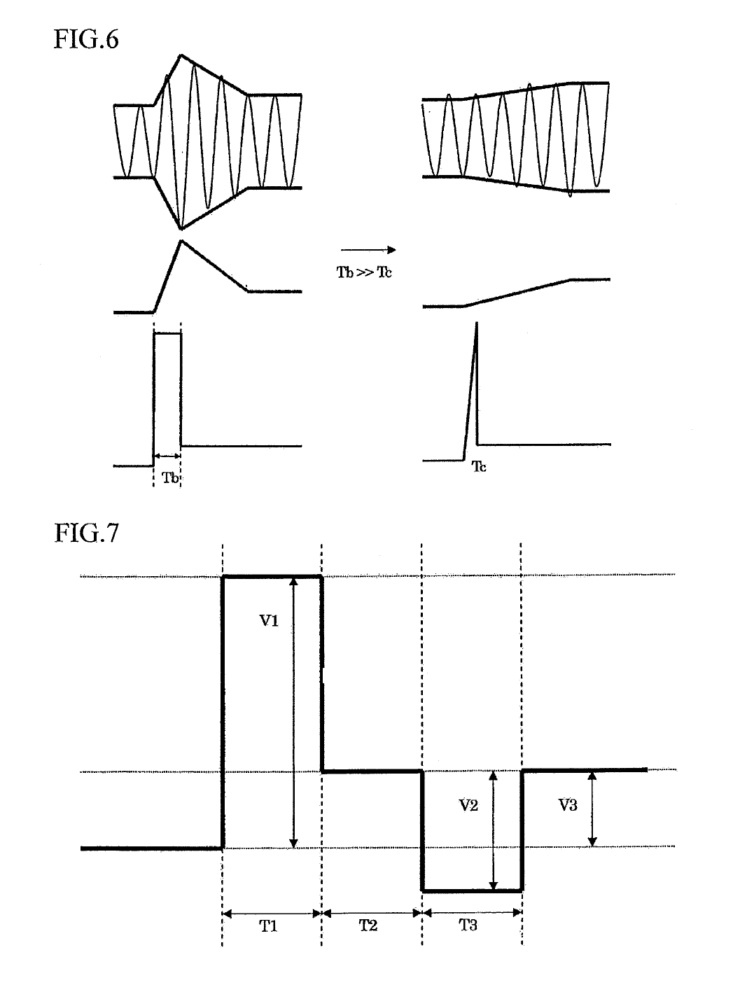

However, as shown in FIG. 6, if the time Tb is too short, energy for acceleration will be insufficient and the scanning range will not be varied.

In this case, the amplitude adjusting section 12 may generate the first adjusting voltage and second adjusting voltage for deceleration, on the basis of the increase-decrease variation of the error signal, so as to cancel the variation and adjust the swing range of the mirror section 4 to the object range. With this action, the scanning range can be desirably converged or adjusted in a short time.

For example, as shown in FIG. 7, the first adjusting voltage V1, whose amplitude is higher than that of the adjusting voltage V3 corresponding to an object amplitude, and the second adjusting voltage V2, whose amplitude is lower than that of the adjusting voltage V3 corresponding to the object amplitude, are generated so as to adjust or converge the swing range of the mirror section 4 on the object range in a short time. In the conventional drive control device, as shown in FIG. 12, only the adjusting voltage V3 is applied to the drive voltage which cannot increase the scanning range to the object range, so it takes a long time to vary the scanning range. Thus, in the present embodiment, the first adjusting voltage V1 (tens of mV) is applied for a time T1. Next, the adjusting voltage V3 (several mV) is applied for a time T2, and then the second adjusting voltage V2 is applied for a time T3 so as to shorten a time of occurring overshoot.

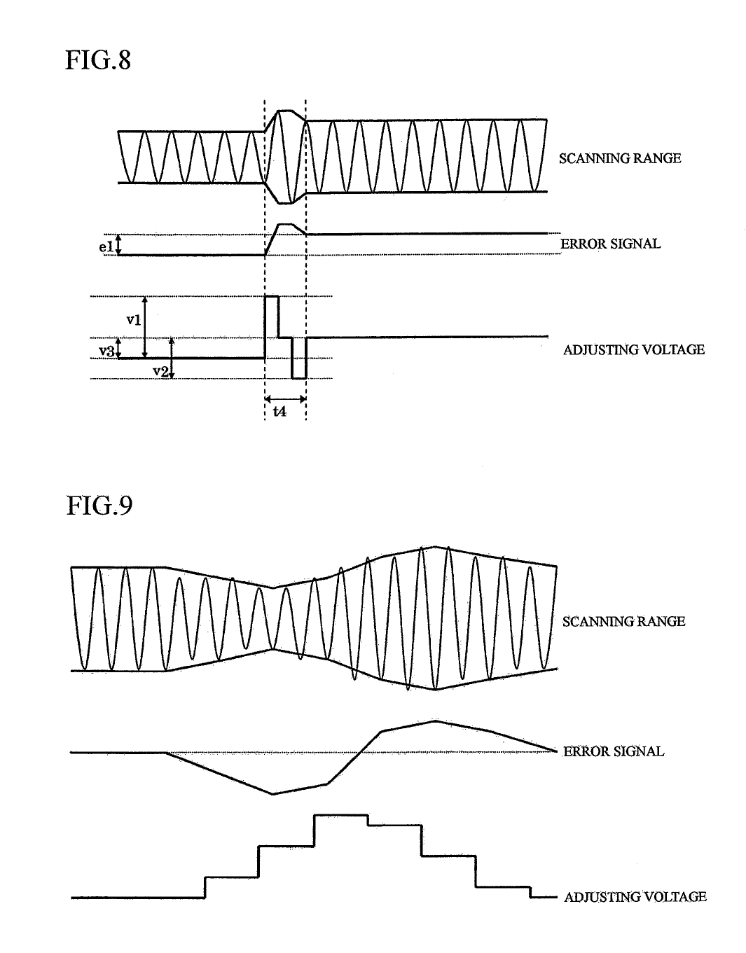

FIG. 8 shows waveform charts, in which the first adjusting voltage V1 and the second adjusting voltage V2 are applied so as to cancel variation e1 (increase-decrease value) of an error signal which indicates that the scanning range of the mirror section 4 is smaller than the object scanning range. If only the first adjusting voltage is applied, the scanning range is significantly varied more than the amount corresponding to the variation e1, so the second adjusting voltage V2 is applied to the adjusting voltage in a moment. By applying both of the first and second adjusting voltage V1 and V2 so as to cancel the variation e1 of the error signal, the scanning range can be changed in a time t4, which is shorter than the time t3 shown in FIG. 4 for changing the scanning range. Therefore, even if the variation e1 of the error signal is separated from a standard value, the scanning range can sharply respond to the first adjusting voltage V1 (kick) and the second adjusting voltage V2 (kickback), so that the scanning range can be stably controlled without significant variation.

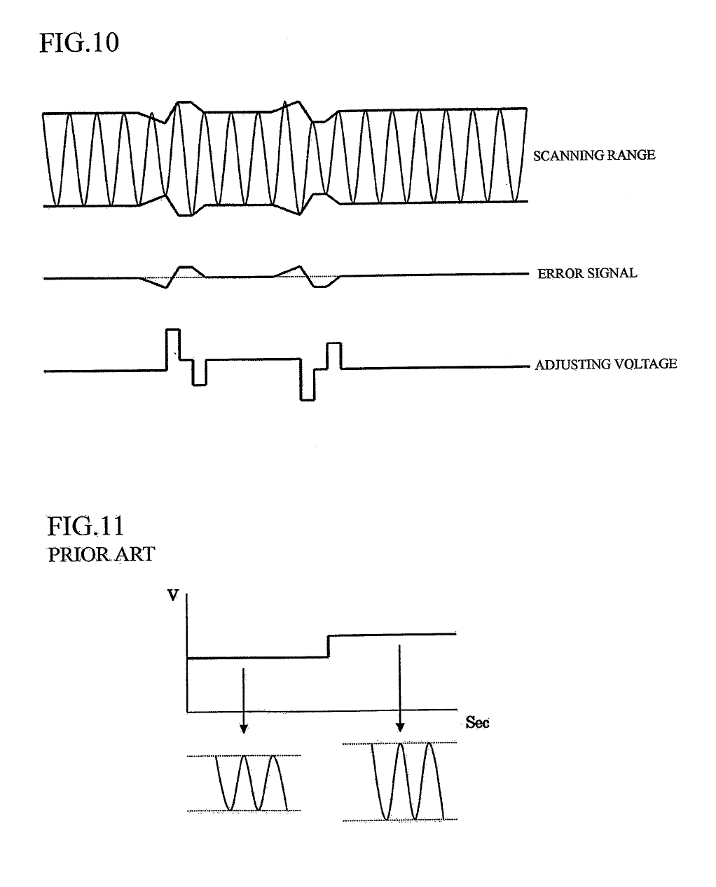

FIG. 9 shows waveform charts of comparative example, in which no first and second adjusting voltage is applied; FIG. 10 shows waveform charts of the example of the present invention, in which the first and second adjusting voltage is applied.

In FIG. 9, feedback control is performed without applying the first and second adjusting voltage. When the scanning range is reduced and variation of the error signal is also reduced, the adjusting voltage is varied. Even after the adjusting voltage is applied, response of varying the scanning range is slow, so the scanning range cannot be adjusted quickly. Therefore, a control section further applies the adjusting voltage. When the variation e1 of the error signal reaches the standard value, high adjusting voltage is applied to the drive voltage. Therefore, the scanning range is further made grater, and the control section tries to reduce the scanning range. Namely, the control section will repeat the above described operations, so stable control cannot be performed.

In FIG. 10, the feedback control is performed with applying the first and second adjusting voltage. Even if the variation of the error signal is greater or less than the standard value, the scanning range can sharply respond to the first adjusting voltage V1 (kick) and the second adjusting voltage V2 (kickback) to cancel the variation of the error signal, so that the scanning range can be quickly varied and converged on the predetermined range, without significant variation. Therefore, the feedback control can be performed stably.

In FIG. 10, if the variation of the error signal is varied from decrease to increase, the first adjusting voltage V1 and the second adjusting voltage V2 is applied in this order. On the other hand, if the variation of the error signal is varied from increase to decrease, the second adjusting voltage V2 and the first adjusting voltage V1 is applied in this order. With these actions, the scanning range can be quickly varied and easily converged on the predetermined range.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention has been described in detail, it should be understood that the various changes, substitutions, and alternations could be made hereto without departing from the spirit and scope of the invention.

What is claimed is:

1. A drive control device of a light scanning apparatus, in which a substrate is vibrated by a vibration source provided on the substrate so as to swing a mirror section on a beam section as a pivot shaft and reflect irradiated light for light scanning,
comprising:
a frequency generating section for generating electric signals having an assigned frequency;
an amplitude adjusting section for adjusting amplitude of the electric signals and outputting the electric signals whose amplitude has been adjusted;
a drive circuit applying drive voltage, which corresponds to the adjusted amplitude of the electric signals sent from the amplitude adjusting section, to the vibration source so as to actuate the vibration source;
a detecting section for detecting a swing range of the mirror section swung by the vibration source, which is actuated by the drive voltage;
a measuring section for measuring a time interval between detection signals outputted by the detecting section;
a standard value setting section for setting and generating a standard value of the time interval between the detection signals; and
a comparing section for comparing the measured time interval, which has been measured by the measuring section, with the standard value of the time interval,
wherein the amplitude adjusting section generates at least one of first adjusting voltage for acceleration, whose amplitude is higher than that of adjusting voltage for obtaining object amplitude, and second adjusting voltage for deceleration, whose amplitude is lower than that of the adjusting voltage for obtaining the object amplitude, and applies the same to the drive circuit for a prescribed time, to perform feedback control, when the comparing section generates an error signal, so as to cancel increase-decrease variation of the error signal.

2. The drive control device according to claim 1,
wherein the amplitude adjusting section generates the first adjusting voltage and the second adjusting voltage on the basis of the increase-decrease variation of the error signal so as to cancel the variation and adjust the swing range of the mirror section to an object swing range.
